(19) United States
(12) Patent Application Publication
(10) Pub. No.: US 2019/0336870 A1
(43) Pub. Date: Nov. 7, 2019

(54) EXPERIENCE APPARATUS

(71) Applicant: SANGWHA Co., Ltd., Seoul (KR)

(72) Inventor: Beom Joon JUNG, Seoul (KR)

(21) Appl. No.: 15/738,980

(22) PCT Filed: Jun. 19, 2017
(86) PCT No.: PCT/KR2017/006416

§ 371 Date: Dec. 21, 2017

(30) Foreign Application Priority Data
Dec. 6, 2016 (KR) 10-2016-0165251

(51) Int. Cl. A63G 31/16; A63G 31/02; G06F 3/01

(52) U.S. Cl. CPC A63G 31/16; G06F 3/012; A63G 31/02

(57) ABSTRACT

The present invention relates to an experience apparatus including: an avatar configured to move in a first space; and a simulator configured to provide stimuli an experiencing person in a second space and enable the experiencing person to undergo experience as being aboard the avatar. Therefore, reality may be improved and the experiencing person may undergo various situations with relatively lesser time and costs.

### TECHNICAL FIELD

Exemplary embodiments of the present invention relate to an experience apparatus, and more particularly, to an experience apparatus capable of enabling an experiencing person to undergo experience as being directly exposed to a predetermined situation.

### BACKGROUND ART

Conventionally, there is a desire for people to undergo a predetermined situation (for example, a situation that is difficult for people to undergo in everyday life) as being exposed to such a predetermined situation without directly undergoing such a situation, and recently, to meet such a desire, an experience apparatus for generating a virtual reality and providing the generated virtual reality to an experiencing person are being developed.

A conventional experience apparatus is disclosed in Korean Registered Utility Model No. 0342223.

However, in such a conventional experience apparatus, there is a problem that reality is degraded. That is, a situation, which is undergone by an experiencing person through the conventional experience apparatus, is a virtual reality generated by a manufacturer in advance through a computer or the like, but it is not a real situation. Considering the time required and the cost, a virtual reality is very difficult to be generated at a level of an actual situation, and thus an experiencing person merely undergoes a virtual reality that is substantially different from the actual situation such that reality is inevitably degraded. Meanwhile, since the conventional experience apparatus provides an image to only an experiencing person, there is a problem in that stimuli sensed by the experiencing person through a visual sense and stimuli sensed by the experiencing person through a physical motion are inconsistent with each other. As a result, there is a problem in that the experiencing person feels a sense of a different feeling and an immersion level of the experiencing person is lowered such that reality is degraded.

In addition, significant time and costs are required for undergoing an experience, and thus there is a problem in that a situation to be undergone is limited. That is, in addition to the time and costs involved in developing and manufacturing an apparatus for providing stimuli to the experiencing person, significant rime and costs are required to manufacture virtual reality. Particularly, time and costs are further increased to improve quality of the virtual reality so as to increase reality. Further, since there is only one virtual reality manufactured through a commitment of such significant time and costs, staggering time and costs are required to manufacture various virtual realities for various experiences. As a result, the quality and kinds of virtual reality that can be manufacture are limited, and thus an experienceable situation is limited.

### TECHNICAL PROBLEM

An object of the present invention is to provide an experience apparatus capable of improving reality.

Also, another object of the present invention is to provide an experience apparatus capable of reducing time and costs required to undergo experience and allowing to undergo various situations.

### TECHNICAL SOLUTION

In accordance with one aspect of the present invention, an experience apparatus includes: an avatar configured to move in a first space; and a simulator configured to provide stimuli an experiencing person in a second space and enable the experiencing person to undergo experience as being aboard the avatar.

The avatar may be configured to collect an image and motion which are undergone by the avatar while moving in the first space and transmit the collected image and the collected motion to the simulator, and the simulator may be configured to provide the image and the motion received from the avatar to the experiencing person.

The avatar may be configured to collect a sound that is undergone by the avatar while moving in the first space and transmit the collected sound, and the simulator may be configured to provide the sound received from the avatar to the experiencing person.

The avatar may include a body forming an exterior appearance; a conveying part configured to move the body; an imaging device configured to collect an image viewed from the body; a motion capture device configured to collect physical motion applied to the body; and a transmission device configured to transmit the image collected by the imaging device and the motion collected by the motion capture device to the simulator.

The conveying part may be configured as a moving object or a living thing and the avatar may be configured so as to be mounted on the moving object or the living thing, or the conveying part may be configured as a driving source of the moving object and the avatar may be configured as the moving object.

The moving object may be any one of a vehicle, an aircraft, a missile, a rocket, and a ship.

The moving object may be configured with a vehicle that is movable along a track provided in the first space.

The track and the moving object may be configured with a scale that is less than that of a case in which the experiencing person is able to be aboard.

A plurality of advertising boards or a plurality of special effect devices may be disposed along the track.

The simulator may include a manipulation device configured to receive input data from the experiencing person; and a communication device electrically connected to the transmission device of the avatar and configured to transmit the input data received from the manipulation device to the transmission device, wherein the avatar is configured such that the conveying device is operated according to the input data received through the manipulation device, the communication device, and the transmission device so that the avatar is operable by the experiencing person.

A shock absorber may be interposed between the body and the imaging device to prevent vibration of the body from being transmitted to the imaging device.

The simulator may include a video device configured to provide the image received from the avatar to the experiencing person; and a boarding device configured to provide the physical motion received from the avatar to the experiencing person.

The imaging device may be configured to collect an omnidirectional image surrounding the avatar, and the video device may be configured to provide an image, which corresponds to a view field of the experiencing person, of the omnidirectional image collected by the imaging device.

The imaging device may be configured to collect an image, which is within a view angle of the imaging device, of the omnidirectional image surrounding the avatar, wherein the view angle of the imaging device is adjusted according to a view field of the experiencing person, and the video device may be configured to provide the image collected by the imaging device.

The video device may be configured with a heat mount display (HMD), a first detector may be provided at the video device to detect motion of the video device, a second detector may be provided at the boarding device to detect motion of the boarding device, and the view field of the experiencing person may be calculated from a subtracted value that is obtained by subtracting a measured value of the second detector from a measured value of the first detector.

The avatar and the simulator may be configured to coincide motion displayed on the video device with motion provided from the boarding device.

the avatar may be configured such that the imaging device collects the image based on a timeline, the motion capture device collects the motion based on the timeline, and the avatar integrates the timeline, and the image and the motion, which are collected based on the timeline, into a single file and transmit the single file to the simulator, and the simulator may be configured such that the video device provides the image based on the timeline to the experiencing person on the basis of the single file, and the boarding device provides the motion based on the timeline to the experiencing person on the basis of the single file.

The simulator may be configured to compare and coincide a target image to be provided from the video device with an actual image provided from the video device at a predetermined frequency interval, and to compare and coincide target motion to be provided from the boarding device with actual motion provided from the boarding device at a predetermined time interval.

The timeline may include a plurality of time stamps, and, a tune stamp corresponding to the target image and the target motion among the plurality of time stamps may be a target time stamp, a time stamp corresponding to the actual image among the plurality of time stamps may he an actual image time stamp, and a time stamp corresponding to the actual motion among the plurality of time stamps may be an actual motion time stamp.

At this point, the simulator may compare the target time stamp with the actual image time stamp to determine whether the target image is coincided with the actual image, and may compare the target time stamp with the actual motion time stamp to determine whether the target motion is coincided with the actual motion.

When the actual image time stamp is prior to the target time stamp, the simulator may enable the video device to provide the image at a rate that is higher than a predetermined rate, when the actual image time stamp is later than the target time stamp, the simulator may enable the video device to provide the image at a rate that is lower than the predetermined rate, when the actual motion time stamp is prior to the target time stamp, the simulator may enable the boarding device to provide the motion at a speed that is higher than a predetermined speed, and when the actual motion time stamp is later than the target time stamp, the simulator may enable the boarding device to provide the motion at a speed that is lower than the predetermined speed.

The boarding device may include a boarding part configured to provide the experiencing person with a space in which the experiencing person is able to be aboard; and a driving part configured to generate motion on the boarding part.

The driving part may be configured with a robot arm having a plurality of degrees of freedom.

The driving part may be configured with a gyro mechanism configured to generate at least one of pitching, yawing, rolling, and a reciprocal motion on the boarding part.

The driving part may include a robot arm having a plurality of degrees of freedom; and a gyro mechanism interposed between a free end of the robot arm and the boarding part and configured to generate at least one of pitching, yawing, rolling, and a reciprocal motion on the boarding part with respect to a free end of the robot arm,

The driving part may be configured with a motion simulator having an arbitrary degree of freedom.

The simulator may be configured to provide the experiencing person with the image and the motion, which are undergone by the avatar, in real time, or to store the image and the motion, which are undergone by the avatar, and then provide the stored image and the stored motion to the experiencing person when the experiencing person wants to undergo again the image and the motion.

### ADVANTAGEOUS EFFECTS

The experience apparatus according to the present invention includes the avatar configured to move in the first space and the simulator configured to apply stimuli to the experiencing person in the second space and enable the experiencing person to undergo experience as being aboard the avatar, thereby improving reality.

In addition, the time and costs required for experience may be reduced, and the experiencing person may undergo various situations.

### DESCRIPTION OF DRAWINGS

FIG. 1 is a perspective view illustrating an experience apparatus according to one embodiment of the present invention.

FIG. 2 is a perspective view illustrating an inside of an avatar in the experience apparatus of FIG. 1.

FIG. 3 is a perspective view illustrating an advertising board installed at a track on which the avatar moves in the experience apparatus of FIG. 1.

FIG. 4 is a perspective view illustrating a special effect device installed at the track on which the avatar moves in the experience apparatus of FIG. 1.

FIG. 5 is a lateral view illustrating a state in which a simulator provides pitching to a boarding part in the experience apparatus of FIG. 1.

FIG. 6 is a plan view illustrating a state in which the simulator provides yawing to the boarding part in the experience apparatus of FIG. 1.

FIG. 7 is a front view illustrating a state in which the simulator provides rolling to the boarding part in the experience apparatus of FIG. 1.

FIG. 8 is a front view illustrating a state in which the simulator provides a reciprocal motion to the boarding part in the experience apparatus of FIG. 1.

FIG. 9 is a diagram for describing the concepts of a view coincidence image and a view correction in the experience apparatus of FIG. 1.

FIG. 10 is a perspective view illustrating an experience apparatus according to another embodiment of the present invention.

FIGS. 11 to 14 are perspective views each illustrating motions provided by a simulator in the experience apparatus of FIG. 10.

### MODE FOR INVENTION

Hereinafter, an experience apparatus according to the present invention will be described in detail with reference to the accompanying drawings.

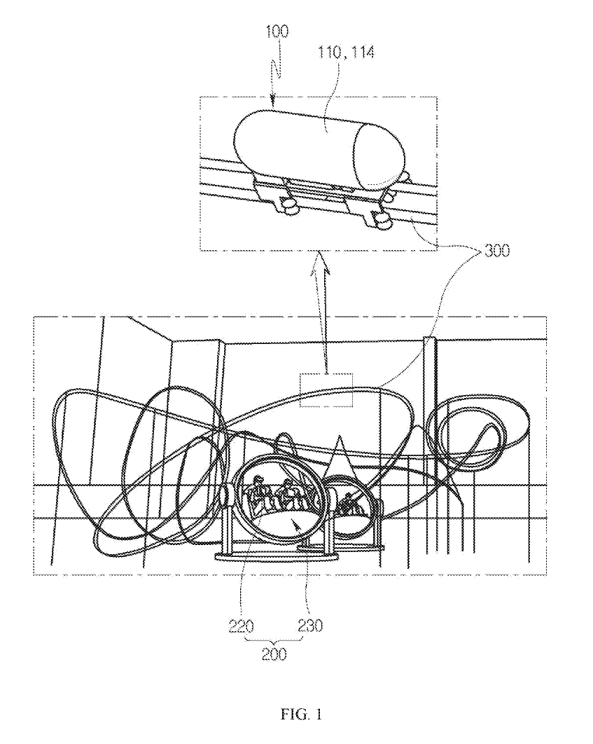

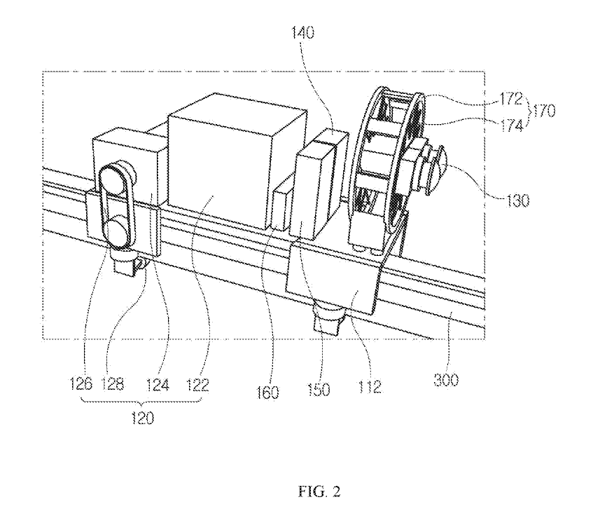

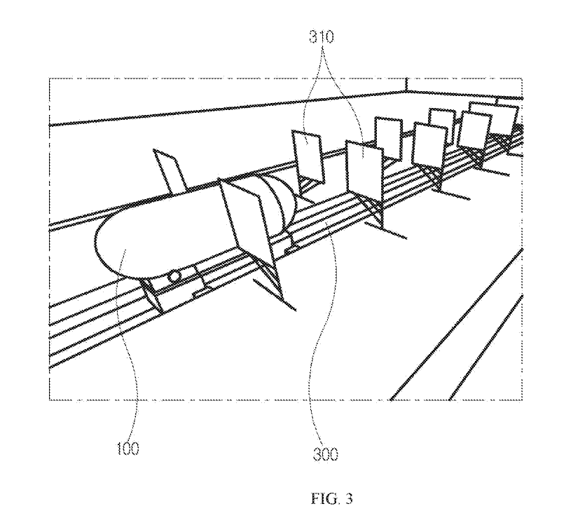

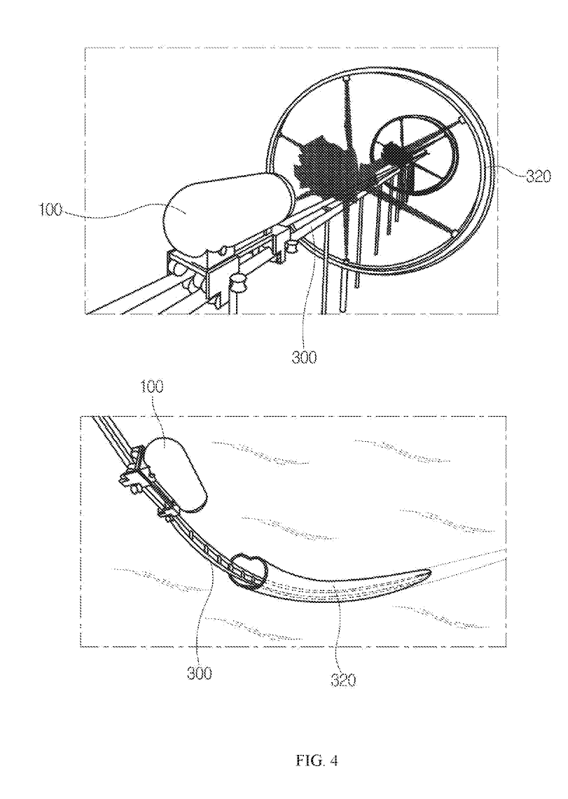

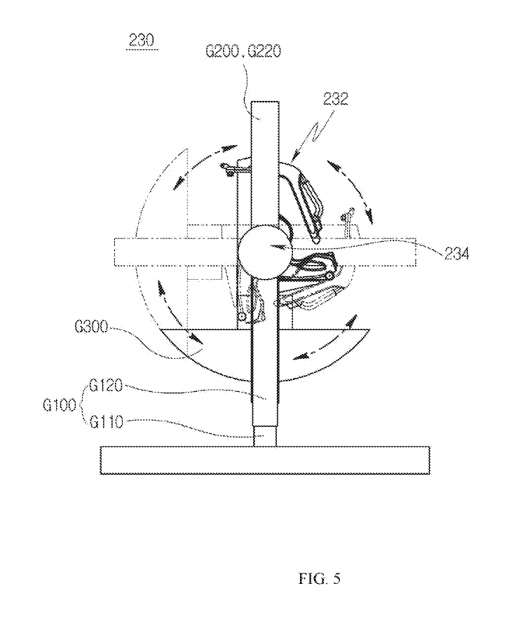

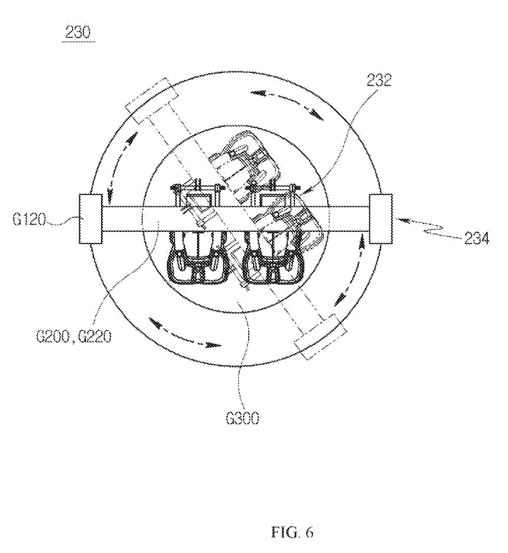

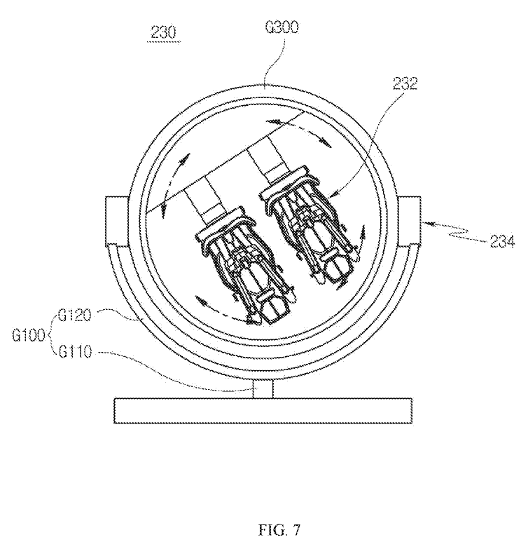

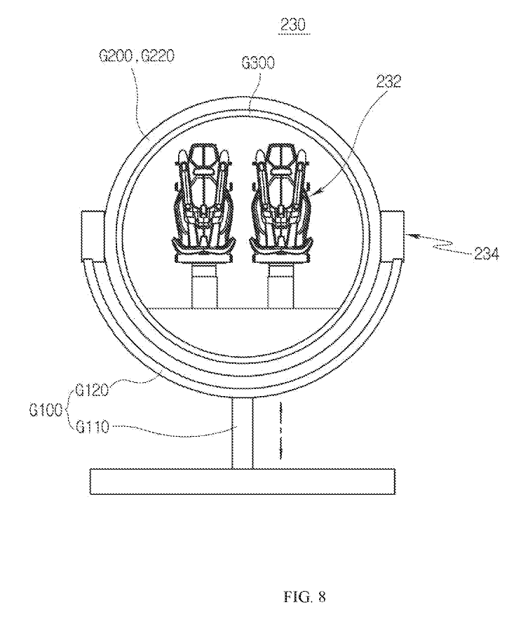

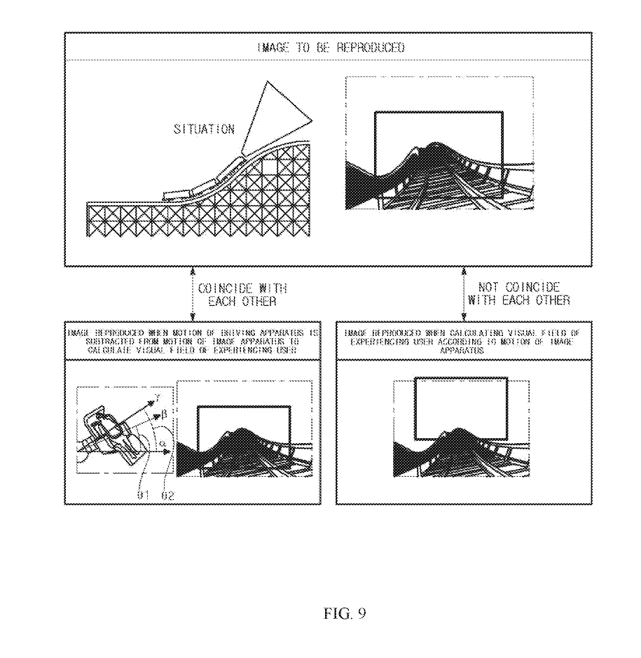

FIG. 1 is a perspective view illustrating an experience apparatus according to one embodiment of the present invention, FIG. 2 is a perspective view illustrating an inside of an avatar in the experience apparatus of FIG. 1, FIG. 3 is a perspective view illustrating an advertising board installed at a track on which the avatar moves in the experience apparatus of FIG. 1, FIG. 4 is a perspective view illustrating a special effect device installed at the track on which the avatar moves in the experience apparatus of FIG. 1, FIG. 5 is a lateral view illustrating a state in which a simulator provides pitching to a boarding part in the experience apparatus of FIG. 1, FIG. 6 is a plan view illustrating a state in which the simulator provides yawing to the boarding part in the experience apparatus of FIG. 1, FIG. 7 is a front view illustrating a state in which the simulator provides rolling to the boarding part in the experience apparatus of FIG. 1, FIG. 8 is a front view illustrating a state in which the simulator provides a reciprocal motion to the boarding part in the experience apparatus of FIG. 1, and FIG. 9 is a diagram for describing the concepts of a view coincidence image and a view correction in the experience apparatus of FIG. 1.

Referring to FIGS. 1 to 9, the experience apparatus according to one embodiment of the present invention may include an avatar 100 configured to move in a first space, and a simulator 200 configured to provide stimuli to an experiencing person in a second space that is a space different from the first space and enable the experiencing person to experience as being aboard the avatar 100.

Here, the space may refer to a space time. That is, as in the present embodiment, the first space and the second space may be concepts that time zones are coincided with each other but positions are different from each other, and as in another embodiment which will be described below, the first space and the second space may be concepts that positions as well as time zones are different from each other. A detailed description thereof will be described below.

The avatar 100 may be configured to collect images and motions undergone by the avatar 100 while moving in the first space and transmit the collected images and the collected motions to the simulator 200.

Particularly, the avatar 100 may include a body 110 configured to form an exterior appearance, a conveying device 120 configured to move the body 110, an imaging device 130 configured to collect an image viewed from the body 110, a motion capture device 140 configured to collect a physical motion applied to the body 110, and a transmission device 150 configured to transmit the image collected by the imaging device 130 and the motion collected by the motion capture device 140 to the simulator 200.

The body 110 may include a frame 112 configured to support the conveying device 120, the imaging device 130, the motion capture device 140, and the transmission device 150, and a cover 114 configured to cover the frame 112.

The conveying device 120 may include a battery 122 configured to store and discharge electric power, a motor 124 configured to convert the electric power supplied from the battery 122 into a driving force, a power transmission mechanism 126 configured to transmit the driving force generated from the motor 124, and a wheel 128 rotated by the driving force received from the power transmission mechanism 126. Here, the conveying device 120 is configured to be driven by the electric power, but it may be configured to be driven by another method (for example, an engine using chemical energy and a transmission).

The imaging device 130 may be configured with a camera (for example, an omnidirectional camera, a binocular type stereoscopic camera having a view angle of over 180 degrees by employing a fisheye lens, and the like) configured to shoot a 360-degree omnidirectional image surrounding the avatar 100 (more particularly, the imaging device 130) or a portion of the 360-degree omnidirectional image.

The motion capture device 140 may be configured to include, for example, a gyro sensor and an acceleration sensor so as to collect a change of direction, deceleration, acceleration, rotation, directionality, and the like.

The transmission device 150 may be configured with a wireless transceiver in a radio frequency (RF) band.

Here, the avatar 100 according to the present embodiment may be formed of a vehicle (for example, a roller coaster) capable of moving along a track 300 provided in the first space, and a plurality of advertising boards 310 for advertising and a plurality of special effect devices 320, which each emit, for example, fire, water, mist, and laser so as to improve attraction, may be disposed along the track 300. Further, to reduce a space and costs required for installation and operation, the avatar 100, the track 300, the advertising board 310, and the special effect device 320 may be configured in a lesser scale (for example, a miniature scale) when compared to a case in which the avatar 100, the track 300, the advertising board 310, and the special effect device 320 are configured to enable the experiencing person to be aboard.

Meanwhile, the avatar 100 may be configured to provide a view coincidence image, which will be described below, of the omnidirectional image in association with the simulator 200. A detailed description thereof will be described below.

Also, the avatar 100 further includes information processing computing board 160, and it may be configured to coincide a motion, which is displayed on a video device 220 which will be described below, with a motion, which is provided from a boarding device 230 which will be described below, in association with the simulator 200. A detailed description thereof will be described below.

In addition, to collect a stable and high quality image, the avatar 100 further include a shock absorber 170 provided between the body 110 and the imaging device 130 and configured to prevent vibration of the body 110 from being transmitted to the imaging device 130. The shock absorber 170 may include an annular part 172 configured to accommodate the imaging device 130 and fixed to the body 110 (more particularly, the frame 112), and a shock-absorbing part 174 interposed between an inner circumferential surface of the annular part 172 and the imaging device 130 and configured to support the imaging device 130 to be relatively movable inside the annular part 172. The shock-absorbing part 174 is radially formed around the imaging device 130, and may be formed of an elastic material, for example, rubber.

The simulator 200 may be configured to provide an image and motion received from the avatar 100 to the experiencing person.

Specifically, the simulator 200 may include a communication device (not shown) electrically connected to the transmission device 150 of the avatar 100 and configured to receive an image and motion (more particularly, a timeline, and a file in which an image and motion are integrated., which are collected based on the timeline) from the avatar 100, a video device 220 configured to provide the experiencing person with the image received through the communication device (not shown), a boarding device 230 configured to provide the experiencing person with the motion received through the communication device (not shown), and a control device (not shown) configured to control the video device 220 and the boarding device 230. Hereinafter, the image provided to the experiencing person is referred to as an experience image, and physical motion provided to the experiencing person is referred to as experience motion.

The communication device (not shown) may be configured with a wireless communication device, it may be configured to receive an image and motion from the transmission device 150 as well as other information such as voice as in another embodiment which will be described below, and transmit information such as input data to the transmission device 150. That is, the transmission device 150 and the communication device (not shown) may be configured to perform a bidirectional communication.

The video device 220 is a device configured to enable the experiencing person to undergo experience as being aboard the avatar 100 through visual sense, and the video device 220 may include an image display (for example, a liquid crystal display) configured to display the experience image.

The boarding device 230 is a device configured to enable the experiencing person to undergo experience as being aboard the avatar 100 through physical motion, and the boarding device 230 may include a boarding part 232 configured to provide a boardable space to the experiencing person, and a driving part 234 configured to drive the boarding part 232 in a rectilinear motion or a rotational motion to provide the experience motion.

The boarding part 232 may include a seat on which the experiencing person is able to be seated, a seat belt configured to prevent the experiencing person from escaping from the seat, and a handle configured to be gripped by the experiencing person so as to provide psychological stabilization to the experiencing person.

Further, the boarding part 232 may further include a cradle on which the video device 220 is detachably seated, an escape prevention part configured to prevent the video device 220 from being spaced away from the cradle more than a predetermined distance, a power cable configured to supply electric power from the cradle to the video device 220, and the like.

The driving part 234 may he configured to provide the experiencing person with physical motion as if the experiencing person is boarding an actual device (for example, the avatar 100), with relatively lesser spatial constraints. That is, motion displayed in the experience image may not be provided through an actual mechanism, but may be provided by the driving part 234 which is operated within a predetermined limited space narrower than a space in which the actual mechanism is operated.

The driving part 234 may be formed in various configurations capable of three-dimensionally moving the boarding part 232, and, in the present embodiment, the driving part 234 may be configured with a gyro mechanism configured to generate pitching, yawing, rolling, and a reciprocal motion in the boarding part 232 so as to minimize a space required for installing the driving part 234 and maximize a degree of freedom in that space. Here, the reciprocal motion means that the boarding part 232 moves in a direction away from and close to a structure configured to support the gyro mechanism.

The gyro mechanism may include a first mechanism G100 configured to generate yawing in the boarding part 232 as shown in FIG. 6 and a reciprocal motion on the boarding part 232 as shown in FIG. 8, a second mechanism G200 configured to generate pitching on the boarding part 232 as shown in FIG. 5, and a third mechanism G300 configured to generate rolling on the boarding part 232 as shown in FIG. 7.

The first mechanism G100 may be configured to rotate and perform a reciprocal motion based on the structure.

Particularly, a first engagement recess (not shown) into which the first mechanism G100 is inserted is formed at the structure, and the first mechanism G100 may include a base part G110 inserted into the first engagement recess (not shown), and an arm part G120 extending from the base part G110 to a side opposite to the structure and configured to support the second mechanism G200.

The base part G110 may be formed to be rotatable based on a depth direction of the first engagement recess (not shown) as a rotation axis in a state of being inserted into the first engagement recess (not shown), and to be reciprocally movable in the depth direction of the first engagement recess (not shown).

Further, a first actuator (not shown)configured to generate a driving force required for a rotational motion of the first mechanism G100 and a second actuator (not shown) configured to generate a driving force required for a reciprocal motion of the first mechanism G100 may be formed between the structure and the first mechanism G100 (more particularly, the base part G110).

Here, although not shown separately, the first mechanism may be formed to be rotatable based on the structure, and a portion of the first mechanism for supporting the second mechanism may be formed to be reciprocable in a direction away from and close to the structure. That is, the arm part includes a first arm portion fixed and coupled to the base part, and a second arm portion configured to support the second mechanism and reciprocally coupled with respect to the first arm portion, and the base part may be formed to perform only a rotational motion based on the depth direction of the first engagement recess as a rotation axis in a state of being inserted into the first engagement recess. In this case, the first actuator may be formed between the structure and the first mechanism, and the second actuator may be formed between the first arm portion and the second aria portion to generate a driving force required for a reciprocal motion of the second arm portion.

The second mechanism G200 may be formed to be supported by the first mechanism G100 (more particularly, the arm part G120) and to be rotatable in a direction perpendicular to a rotation axis of the first mechanism G100.

Particularly, a second engagement recess (not shown) extending in a direction perpendicular to the depth direction of the first engagement recess (not shown) is formed at the arm part G120 of the first mechanism G100, and the second mechanism G200 may include a hinge part (not shown) and an annular frame part G220 annularly extending from the hinge part (not shown) and configured to support the third mechanism G300. Here, the hinge part (not shown) may be formed to extend from an outer circumferential portion of the annular frame part G220 to the outside of a radius direction of the annular frame part G220.

The hinge part (not shown) may be formed to be rotatable based on a depth direction of the second engagement recess as a rotation axis in a state of being inserted into the second engagement recess (not shown).

Further, a third actuator (not shown) may be formed between the arm part G120 of the first mechanism G100 and the second mechanism G200 (more particularly, the hinge part) to generate a driving force required for the rotational motion of the second mechanism G200.

The third mechanism G300 may be formed to be supported on the second mechanism G200 (more particularly, the annular frame part) and to be rotatable in a direction perpendicular to the rotation axis of the first mechanism G100 and the rotation axis of the second mechanism G200. At this point, the boarding part 232 may be fixed and coupled to the third mechanism G300.

Particularly, the third mechanism G300 may be formed in an annular shape concentric with the second mechanism G200 (more particularly, the annular part 172), and an outer circumferential surface of the third mechanism G300 may be rotatably coupled to an inner circumferential surface of the second mechanism G200 (more particularly, the annular frame part).

Further, a fourth actuator (not shown) may be formed between the inner circumferential surface of the second mechanism G200 and the outer circumferential surface of the third mechanism G300 to generate a driving force required for a rotational motion of the third mechanism G300.

Here, the third mechanism G300 may be circumferentially slidably coupled with respect to the inner circumferential surface of the second mechanism G200 in a state in which the entire outer circumferential surface of the third mechanism G300 faces the entire inner circumferential surface of the second mechanism G200.

Meanwhile, the number of the boarding parts 232 and the number of the driving parts 234 may be appropriately adjusted. That is, a single boarding part 232 may be coupled to a single driving part 234 so as to enable a single experiencing person to undergo experience at a time. Alternatively, a plurality of boarding parts 232 may be coupled to a single driving part 234 to enable a plurality of experiencing persons to undergo experience at a time and to improve a turnover ratio, Alternatively, to further improve the turnover ratio, a plurality of the driving parts 234 may be provided, and at least one boarding part 232 may be coupled to each of the plurality of driving parts 234.

The control device (not shown) may be formed of a server or a computer electrically connected to the avatar 100, the video device 220, and the boarding device 230, and may include an image controller configured to control the video device 220, a driving controller configured to control a driving device, and an integrated controller configured to control the image controller and the driving controller.

Here, to enable the experiencing person to see an image as being in an actual situation (as being aboard in the avatar 100), the avatar 100 and the simulator 200 may be configured in a method such that the experiential image is provided with an image corresponding to the experiencing person's eyes (that is an image in a direction of experiencing person's eyes when assuming a case in which the experiencing person boards the avatar 100, and hereinafter, referred to as a view coincidence image) of an image surrounding the experiencing person (that is an image surrounding the avatar 100, and hereinafter, referred to as an omnidirectional image).

That is, the experience image may be formed of the omnidirectional image, and may be formed to be displayed on the image display as the view coincidence image corresponding to a specific portion (that is a portion gazed by the experiencing person's eyes) of the omnidirectional image.

Particularly, the imaging device 130 may be configured to collect the omnidirectional image surrounding the avatar 100 as described above.

Further, the video device 220 and the controller (not shown) may be configured to enable the view coincidence image corresponding to the specific portion (that is the portion gazed by the experiencing person's eyes) of the omnidirectional image collected by the avatar 100 to be displayed as the experience image on the image display.

More particularly, the video device 220 may further include a first detector (not shower) formed of, for example, a head mounted display (HMD) mounted on a head of an experiencing person and configured to detect motion of the video device 220. Here, the first detector (not shown) may be configured with, for example, a gyro sensor, an acceleration sensor, and the like.

The control device (not shown) may be configured to store the omnidirectional image received from the avatar 100, periodically receive a measured value (that is motion of the video device 220 detected through the first detector (not show of the first detector (not shown), calculate a view field of the experiencing person based on the measured value of the first detector (not shown), and transmit an image, which corresponds to the calculated view field of the experiencing person, of the omnidirectional image to the image display (so as to enable the image display to display the image received from the control device (not shown)).

However, in this case, the motion of the video device 220, which is detected through the first detector (not shown), may be affected by changing of the experiencing person's eyes as well as the motion of the boarding device 230 (an experience motion). For example, even when the boarding device 230 moves upward while the experiencing person keeps his or her eyes forward, the first detector (not shown) may detect that the video device 220 is moved upward. Accordingly, when the experiencing person changes his or her eyes in a state in which the boarding device 230 does not move, the motion of the video device 220, which is detected through the first detector (not shown), is coincided with motion of the video device 220 due to the change of the experiencing person's eves, so that the view field of the experiencing person, which is calculated based on the measured value of the first detector (not shown), may be coincided with a view field of an actual experiencing person. However, when the boarding device 230 moves, the motion of the video device 220 detected through the first detector (not shown) is not coincided with the motion of the video device 220 due to the change of the experiencing person's eyes, so that the view field of the experiencing person, which is calculated based on the measured value of the first detector (not shown)may not be coincided with the view field of an actual experiencing person.

In consideration of such circumstances, in the present embodiment, when calculating the view field of the experiencing person, the simulator 200 may be configured with a method (hereinafter, referred to as a view field correction method) of excluding the motion of the video device 220 due to the motion of the boarding device 230 (that is the experience motion). That is, the boarding device 230 may be configured to include a second detector (not shown) configured to detect the motion of the boarding device 230 (which is the experience motion), and the control device (not shown) is configured to subtract a measured value of the second detector (not shown) (which is motion of an image part according to the motion of the boarding device 230) from the measured value of the first detector (not shown), and calculate the view field of the experiencing person based on the subtracted value (that is, motion of the image part according to the change of the view field of the experiencing person).

Particularly, referring to FIG. 9, when an angle between a reference vector α (for example, a vector from a start point of experience toward a front side of the experiencing person a d a vector β in a direction at which the experiencing person gazes is a first angle θ1, and an angle between the reference vector α and a vector γ toward the front side of the experiencing person is a second angle θ2, the first detector (not shown) may detect the first angle θ1 and transmit the detected first angle θ1 to the control device, the second detector (not shown) may detect the second angle θ2 and transmit the detected second angle θ2 to the control device, and the control device may subtract the second angle θ2 from the first angle θ1 and calculate the view field of the experiencing person based on the subtracted value θ1−θ2. Thus, an image corresponding to a view field of an actual experiencing person may be provided.

The second detector (not shown) may be configured with a gyro sensor, an acceleration sensor, and the like, which are installed at the boarding part 232, or may be configured in a sensor interface method capable of sensing motion of each joint (each actuator) of the driving part 234 and calculate the motion of the boarding part 232.

Meanwhile, the avatar 100 and the simulator 200 may be configured to coincide video motion (visual motion) displayed on the video device 220 with motion (physical motion) provided from the boarding device 230. That is, the avatar 100 and the simulator 200 may be configured such that the experience image and the experience motion are synchronized with each other.

Particularly, when the motion shown in the experience image and the motion actually provided from the experience motion are inconsistent with each other, the experiencing person feels a different feeling and an immersion level is lowered so that reality may be degraded.

In consideration of such circumstances, in the present embodiment, the motion to be displayed on the experience image and the motion to be provided from the experience motion may be primarily coincided with each other in collecting of the image and the motion through the avatar 100, and the motion displayed on the experience image and the motion provided from the experience motion may he secondarily coincided with each other in reproducing of the image and the motion through the simulator 200.

More particularly, the avatar 100 may be configured to collect an image captured by the imaging device 130 based on the timeline through the computing board 160, collect motion measured by the motion capture device 140 based on the timeline, integrate the timeline and the image and the motion, which are collected based on the timeline, into a single file, and transmit the single file to the simulator 200. Hereinafter, the file is referred to as an integrated file. In this case, when compared to a case in which the image and the motion are separately collected and transmitted, a phenomenon in which a delay between the image and the motion occurs in the collecting of the image and the motion is significantly reduced, and thus motion to be displayed on the video device 220 and motion to be provided from the hoarding device 230 may be easily coincided with each other.

Based on the integrated file received from the avatar 100, the simulator 200 may be configured such that the video device 220 provides an image to the experiencing person based on the timeline and the boarding device 230 provides motion to the experiencing person based on the timeline.

That is, the integrated file may include first to n-th time stamps, which are a plurality of time points included in an experience time from an experience start time to an experience end time, first to n-th images corresponding to the first to the n-th time stamps, respectively, and first to n-th motions corresponding to the first to the n-th time stamps, respectively. Here, the first to the n-th timestamps form the timeline.

The integrated file may be stored in the control device(not shown), the integrated controller of the control device (not shown) may simultaneously sequentially transmit the first to n-th time stamps to the image controller and the driving controller at a predetermined interval (for example, 10 milliseconds (ms)), the image controller of the control device (not shown) may select images corresponding to time stamps, which are received from the integrated controller, among the first to n-th images and transmit a view coincidence image among the selected images to the image display, and the driving control unit of the control device (not shown) may select motion corresponding to a tune stamp, which is received from the integrated controller, among the first to n-th motions and transmit the selected motion to the driving part 234.

Then, the simulator 200 may be configured to compare and coincide a target image (an image to be provided by the video device 220) and an actual image (an image provided by the video device 220) with each other at an interval of a predetermined frequency (for example, 60 Hertz (Hz)) so as to continuously synchronize the image with the motion while undergoing the experience, and to compare and coincide target motion (motion to be provided by the boarding device 230) and actual motion (motion provided by the boarding device 230) with each other at an interval of a predetermined time interval (for example, 12 ms).

To describe this in more detail below, time stamps (time stamps transmitted from the integrated controller) corresponding to the target image and the target motion among the first to n-th time stamps will be referred to as target time stamps, a time stamp (a time stamp transmitted to the image display) corresponding to the actual image will be referred to as an actual image time stamp, and a time stamp (a time stamp transmitted to the driving part 234) corresponding to the actual motion will be referred to as an actual motion time stamp.

At this time, the simulator 200 may be configured to compare the target time stamp with the actual image time stamp to determine whether the target image is coincided with the actual image. When the actual video time stamp is prior to the target time stamp, the simulator 200 may be configured to enable the video device 220 to provide an image at a rate that is higher than a predetermined rate. Further, when the actual video time stamp is later than the target time stamp, the simulator 200 may be configured to enable the video device 220 to provide the image at a rate that is lower than the predetermined rate.

In addition, the simulator 200 may be configured to compare the target time stamp with the actual motion time stamp to determine whether the target image is coincided with the actual motion. When the actual motion time stamp is prior to the target time stamp, the simulator 200 may be configured to enable the driving part 234 to provide motion at a speed that is higher than a predetermined speed. Further, when the actual motion time stamp is later than the target time stamp, the simulator 200 may be configured to enable the driving part 234 to provide the motion at a speed that is lower than the predetermined speed.

Hereinafter, an operational effect of the experience apparatus according to the present embodiment will be described.

That is, when the experiencing person boards the boarding device 230 (more particularly, the boarding part 232) and preparation for experience is completed, the experience may start.

When the experience starts, the avatar 100 may move in the first space by the conveying device 120 and may form an image and motion, which are undergone by the avatar 100, as the integrated file through the imaging device 130, the motion capture device 140, the computing board 160, and the transmission device 150 to transmit the integrated file to the simulator 200 in the second space.

Then, the simulator 200 may provide the image and the motion, which are undergone by the avatar 100, to the experiencing person in real time through the communication device not shown), the control device(not shown), the video device 220, and the boarding device 230.

Here, the experience apparatus according to the present embodiment includes the avatar 100 configured to move in the first space and the simulator 200 configured to provide stimuli to the experiencing person so as to enable the experiencing person in the second space to undergone a situation as being aboard the avatar 100.

Thus, the experience apparatus according to the present embodiment may improve reality.

That is, a situation that is undergone by the experiencing person through the experience apparatus is not a virtual reality manufactured by a manufacturer in advance through a computer and the like, but a real situation (the first space undergone by the avatar 100).

Further, as the video device 220 and the boarding device 230 are included, stimuli sensed by the experiencing person through a visual sense and stimuli sensed by the experiencing person through physical motion may be coincided with each other. Through this, the experiencing person may be prevented from undergoing a different feeling and an immersion level may be increased such that reality may be improved.

Further, as the experience image and the experience motion are synchronized with each other, the stimuli sensed by the experiencing person through the visual sense and the stimuli sensed h the experiencing person through the physical motion may be further coincided with each other.

In addition, since the view coincidence image of the omnidirectional image is provided, the reality may be further improved. Particularly, the motion of the boarding device 230 is excluded when the view field of the experiencing person, which is required for providing the view coincidence image, is calculated so that a case, in which the actual view field of the experiencing person and the view field of the image are not coincided with each other due to the motion of the boarding device 230, is prevented in advance such that the reality may be further improved.

Further, the experience apparatus according to the present embodiment may enable the experiencing person to undergo various situations with relatively lesser time and costs.

That is, the experiencing person may undergo not the virtual reality, but the actual situation in the first space through the avatar 100. Accordingly, since the virtual reality is not manufactured, time and costs required for manufacturing the virtual reality may be reduced. Although time and costs are required to manufacture the avatar 100 and the first space (that is, the track 300 in present embodiment) instead of manufacturing the virtual reality, the time and the costs are less than those required for manufacturing the virtual reality, and, when the avatar 100 and the first space are manufactured in a miniature scale, the time and the costs may be significantly reduced. Here, in the case of the miniature scale, time and costs required for changing a configuration of the first space may be reduced, That is, for the purpose of providing new experience, a time and costs are considerably required to change the track 300 on the actual roller coaster, but in the present embodiment, a lesser time and lesser costs may be required to change the track 300. Further, in the case of the miniature scale, the time and the costs required to install the advertising board 310 and the special effect device 320 are reduced so that a maximum effect may be obtained with a minimum cost.

In addition, since the time and the costs required to configure the avatar 100 and the first space are less, the avatar 100 and the first space may be configured at various positions within a limited budget and one of them may be selectively linked to the simulator 200. That is, for example, a first track and a first avatar moving on the first track may be configured in Hawaii, a second track and a second avatar moving on the second track may be configured in the Alps, a third track and a third avatar moving on the third track may be configured in Kenya, and a fourth track and a fourth avatar moving on the fourth track may be configured under the Pacific Ocean, and a simulator selectively linked to one of the first avatar, the second avatar, the third avatar, and the fourth avatar may be configured in Seoul. In this case, it is possible to provide a wide variety of experiences with relatively lesser time and costs.

Further, since the stimuli are provided to the experiencing person through the simulator 200, it is possible to provide motion to the experiencing person as being aboard the actual apparatus with a lesser space constraint and relatively lesser time and costs.

Meanwhile, in the case of the present embodiment, the avatar 100 is configured in a form of a vehicle moving along the track 300 (a predetermined course), but there may be a wide variety of other embodiments.

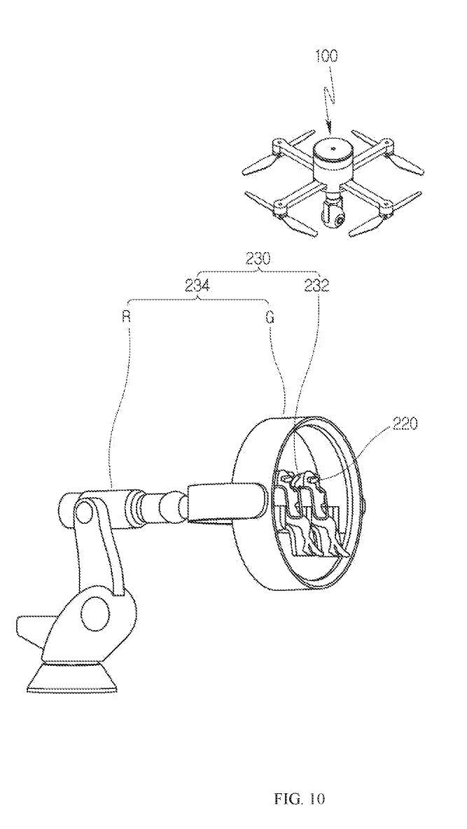

That is, the avatar 100 may be configured with a freely movable object (a moving device) that replaces the view field in simulation. That is, the avatar 100 may be configured with a vehicle that freely travels on the road, an aircraft such as a drone as shown in FIG. 10, a missile, a rocket, a ship, and the like which are not separately shown. In this case, the avatar 100 may freely move, for example, sightseeing spots, foreign attractions, and the like, so that the experiencing person may undergo the same experience as traveling.

Here, the avatar 100 may be configured to be operated by an administrator, but it may be configured to be operated by the experiencing person so as to enable the experiencing person may undergo a desired situation. That is, the simulator 200 may further include a manipulation device (not shown) configured to receive input data from the experiencing person, and the simulator 200 may be configured such that the input data is transmitted to the avatar 100 through the communication device (not shown), and the avatar 100 may be configured such that the conveying device 120 is operated according to the input data.

Further, in the above-described embodiment, the avatar 100 itself is configured with the moving object (that is, the conveying device 120 is a driving source of the moving object), but the avatar 100 may be configured to be mounted on a moving object (that is, the conveying device 120 is configured as the moving object). That is, the avatar 100 may be configured as a unit installed at a vehicle, an aircraft, a missile, a rocket, a ship, and the like. In this case, the experiencing person may undergo experience as being aboard the vehicle, the aircraft, the missile, the rocket, the ship, and the like, and the avatar 100 may be utilized for development and performance evaluation of the vehicle, the aircraft, and the like. Alternatively, the avatar 100 may be configured a wearable device and may be affixed to living things. In this case, the avatar 100 may be mounted on, for example, an animal such as a whale and the like, so that the experiencing person may undergo experience as riding the animal, or the avatar 100 may be utilized for ecology research of the animal. Further, the avatar 100 may be attached to, for example, a person such as a ski jump player so that the experiencing person may undergo the same experience as that of the person.

Meanwhile, in the present embodiment, the experience undergone by the avatar 100 is provided to the experiencing person in real time by the simulator 200, but, the experience undergone by the avatar 100 may be stored and the simulator 200 may frequently provide the experiencing person (for example, when the experiencing person wants to undergo the stored experience). For example, the avatar 100 may be configured with a wearable device, and at a first time point, a person (hereinafter, referred to as a user) may undergo skydiving experience after wearing the avatar 100. Then, the experience that is undergone at the first time point is stored as a file in a predetermined storage device (for example, a memory built in the simulator 200), and then at a second time point later than first time point, the user may be aboard the simulator 200 and reproduce the stored file to undergo again the skydiving experience that is undergone at the first time point. In this case, the user at the first tine point (or the wearable device worn on the user at the first time point) may become the avatar 100, and the user at the second time point may become an experiencing person who is aboard the simulator 200. Accordingly, the experiencing person may transcend time and space and feel inspiration at that time again by undergoing the experience that he or she undergone in the past.

Meanwhile, in the present embodiment, the avatar 100 (more particularly, the imaging device) is configured to collect the omnidirectional image, and the simulator 200 (more particularly, the control device and the imaging device) is configured to receive the omnidirectional image and then provide a view coincidence image thereof. However, the avatar 100 may be configured to collect an image within a view angle of the imaging device 130 among the omnidirectional images, wherein the view angle of the imaging device 130 is adjusted according to the view field of the experiencing person, and the simulator 200 may be configured to provide the collected image to the imaging device 130. That is, the avatar 100 may be configured to collect a portion image of the omnidirectional image from the image collecting instead of the omnidirectional image, and the simulator 200 may be configured to reproduce the portion image, wherein the portion image becomes an image corresponding to the view field of the experiencing person. Here, a line of sight (a view angle) of the imaging device 130 may be adjusted according to the view field calculated as described above. In this case, a size of data to be collected, transmitted, and stored is reduced, and thus a processing speed may be increased.

Meanwhile, in the present embodiment, the driving part 234 is configured with a gyro mechanism capable of providing all pitching, yawing, rolling, and a reciprocal motion, but it may also be configured with a gyro mechanism capable of providing only some of the pitching, the yawing, the rolling, and the reciprocal motion.

Alternatively, the driving part 234 may be configured with a robot arm including a plurality of arms and joints and capable of moving with a plurality of degrees of freedom (for example, 6 degrees of freedom). At this time, the boarding part 232 may be detachably coupled to a free end of the robot arm. In this case, for example, an industrial robot may be used so that the time and costs required for development of the driving part 234 may be reduced.

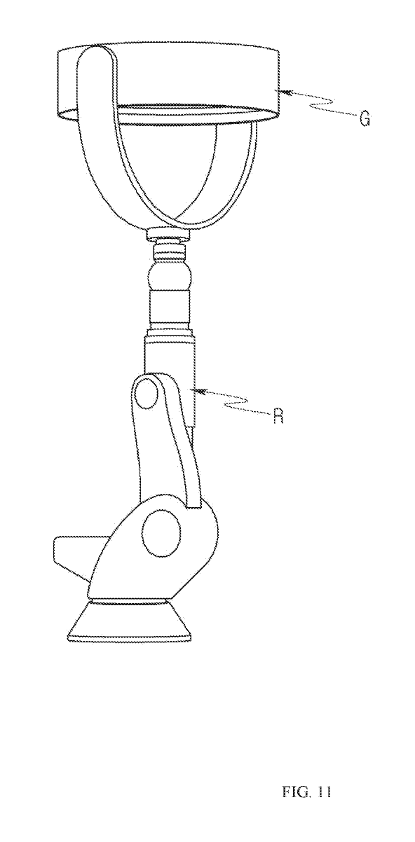

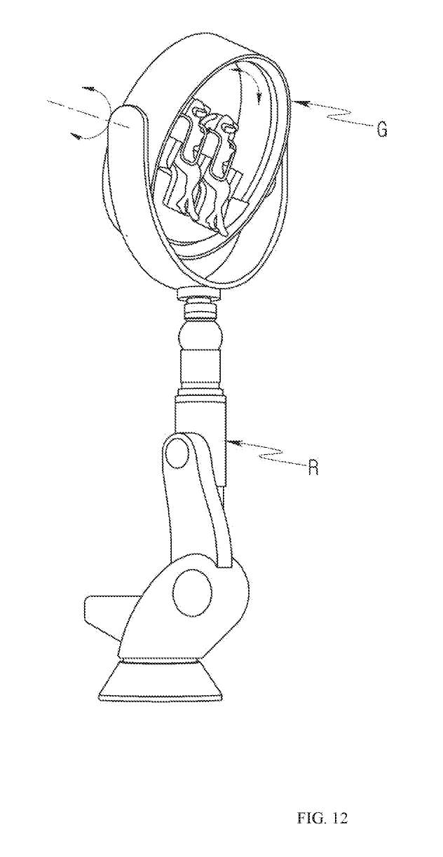

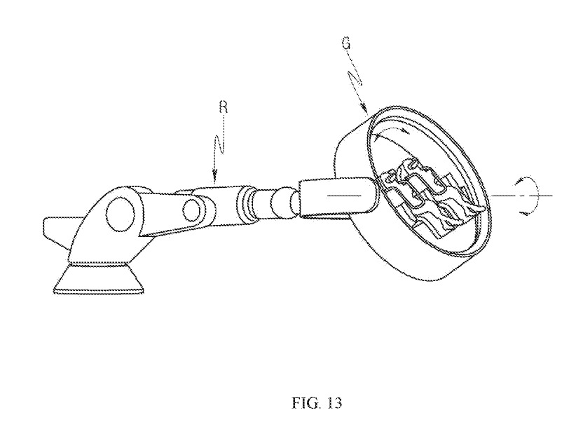

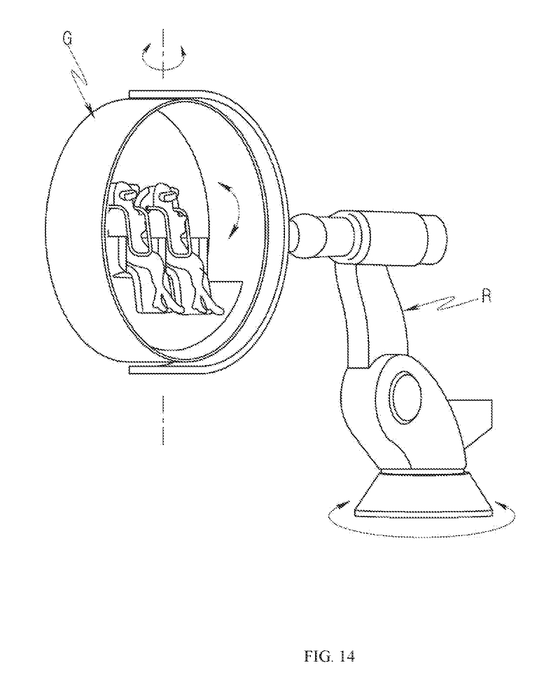

Alternatively, the driving part 234 may be configured to include the robot arm and the gyro mechanism as shown in FIGS. 10 to 14. At this time, the boarding part 232 may be coupled to the third mechanism G300 of the gyro mechanism, and the gyro mechanism may be coupled to the free end of the robot arm. In this case, motion that cannot be realized by the robot arm may be provided. For example, referring to FIGS. 11 and 12, in a state in which the robot arm locates the boarding part 232 at an uppermost position, the gyroscopic mechanism may generate at least one of pitching, yawing, rolling, and a reciprocal motion on the boarding part 232 so that the experiencing person may take various positions even at the uppermost position. As another embodiment, referring to FIG. 13, in a state in which the robot arm locates the boarding part 232 at a frontmost position, the gyroscopic mechanism may generate at least one of pitching, yawing, rolling, and a reciprocal motion on the boarding part 232 so that the experiencing person may take various positions even at the frontmost position. As still another embodiment, referring to FIG. 14, in a state in which the robot arm revolves the boarding part 232 with respect to the ground, the gyro mechanism generates at least one of pitching, yawing, rolling, and a reciprocal motion on the boarding part 232 so that the experiencing person may rotate in a state in which the experiencing person is revolved, or may take various positions.

Also, the driving part 234 may be configured with, for example, a motion simulator having an arbitrary degree of freedom such as a motion device.

Meanwhile, in the present embodiment, the experience may be provided through the image and the motion, but it may be provided through a sound in addition to the image and the motion. That is, the avatar 100 may further include a sound recording device (not shown) configured to collect a sound generated from the body 110, and the simulator 200 may further include a speaker (not shown) configured to provide the experiencing person with the sound collected by the avatar 100. At this time, the sounds may be collected and provided according to the same principle as in the image and the motion. That is, the sound collected through the sound recording device (not shown) may be provided together with the image and the motion in the integrated file through the computing board 160, may be transmitted to the control device (not shown) through the transmission device 150 and the communication device (not shown), and may be synchronized with the image and the motion and reproduced.

### INDUSTRIAL APPLICABILITY

The present invention relates to the experience apparatus that enables the experiencing person to undergo experience as being directly exposed to a predetermined situation, and the experience apparatus is capable of improving the reality, reducing the time and costs required for undergoing the experience, and enabling the experiencing person to undergo various situations.

1-26. (canceled)

27. An experience apparatus comprising:
an avatar configured to move in a first space; and
a simulator configured to provide stimuli an experiencing person in a second space and enable the experiencing person to undergo experience as being aboard the avatar.

28. The experience apparatus of claim 27, wherein the avatar collects an image and motion which are undergone by the avatar while moving in the first space and transmits the collected image and the collected motion to the simulator, and
the simulator provides the image and the motion received from the avatar to the experiencing person.

29. The experience apparatus of claim 28, wherein the avatar collects a sound that is undergone by the avatar while moving in the first space and transmits the collected sound to the simulator, and
the simulator provides the sound received from the avatar to the experiencing person.

30. The experience apparatus of claim 28, wherein the avatar includes:
a body forming an exterior appearance;
a conveying part configured to move the body;
an imaging device configured to collect an image viewed from the body;
a shock absorber interposed between the body and the imaging device and configured to prevent vibration of the body from being transmitted to the imaging device;
a motion capture device configured to collect physical motion applied to the body; and
a transmission device configured to transmit the image collected by the imaging device and the motion collected by the motion capture device to the simulator.

31. The experience apparatus of claim 30, wherein the conveying part is configured as a moving object or a living thing, and the avatar is configured so as to be mounted on the moving object or the living thing, or
wherein the conveying part is configured as a driving source of the moving object, and the avatar is configured as the moving object, and
wherein the moving object is any one of a vehicle, an aircraft, a missile, a rocket, and a ship.

32. The experience apparatus of claim 31, wherein the moving object is configured with a vehicle that is movable along a track provided in the first space,
the track and the moving object are configured in a scale that is less than that of a case in which the experiencing person is able to be aboard, and
a plurality of advertising boards or a plurality of special effect devices are disposed along the track.

33. The experience apparatus of claim 30 wherein the simulator includes:
a manipulation device configured to receive input data from the experiencing person; and
a communication device electrically connected to the transmission device of the avatar and configured to transmit the input data received from the manipulation device to the transmission device,
wherein the avatar is configured such that the conveying device is operated according to the input data received through the manipulation device, the communication device, and the transmission device so that the avatar is operable by the experiencing person.

34. The experience apparatus of claim 30, wherein the simulator includes:
a video device configured to provide the image received from the avatar to the experiencing person; and
a boarding device configured to provide the physical motion received from the avatar to the experiencing person.

35. The experience apparatus of claim 34, wherein the imaging device is configured to collect an omnidirectional image surrounding the avatar,
the video device is configured to provide an image, which corresponds to a view field of the experiencing person, of the omnidirectional image collected by the imaging device,
the video device is configured with a heat mount display (HMD),
a first detector is provided at the video device to detect motion of the video device,
a second detector is provided at the boarding device to detect motion of the boarding device, and
the view field of the experiencing person is calculated from a subtracted value that is obtained by subtracting a measured value of the second detector from a measured value of the first detector.

36. The experience apparatus of claim 34, wherein the imaging device is configured to collect an image, which is within a view angle of the imaging device, of the omnidirectional image surrounding the avatar, wherein the view angle of the imaging device is adjusted according to a view field of the experiencing person,
the video device is configured to provide the image collected by the imaging device,
the video device is configured with a heat mount display (HMD),
a first detector is provided at the video device to detect motion of the video device,
a second detector is provided at the boarding device to detect motion of the boarding device, and
the view field of the experiencing person is calculated from a subtracted value that is obtained by subtracting a measured value of the second detector from a measured value of the first detector.

37. The experience apparatus of claim 34, wherein the avatar and the simulator are configured to correspond motion displayed on the video device to motion provided from the boarding device.

38. The experience apparatus of claim 37, wherein the avatar is configured such that the imaging device collects the image based on a timeline, the motion capture device collects the motion based on the timeline, and the avatar integrates the timeline, and the image and the motion, which are collected based on the timeline, into a single file and transmit the single file to the simulator, and
the simulator is configured such that the video device provides the image based on the timeline to the experiencing person on the basis of the single file, and the boarding device provides the motion based on the timeline to the experiencing person on the basis of the single file.

39. The experience apparatus of claim 38, wherein the simulator is configured to compare and coincide a target image to be provided from the video device with an actual image provided from the video device at a predetermined frequency interval, and
to compare and coincide target motion to be provided from the boarding device with actual motion provided from the boarding device at a predetermined time interval.

40. The experience apparatus of claim 39, wherein the timeline includes a plurality of time stamps, and, when a time stamp corresponding to the target image and the target motion among the plurality of time stamps is a target time stamp, a time stamp corresponding to the actual image among the plurality of time stamps is an actual image time stamp, and a time stamp corresponding to the actual motion among the plurality of time stamps is an actual motion time stamp,
the simulator compares the target time stamp with the actual image time stamp to determine whether the target image is coincided with the actual image, and
compares the target time stamp with the actual motion time stamp to determine whether the target motion is coincided with the actual motion.

41. The experience apparatus of claim 40, wherein, when the actual image time stamp is prior to the target time stamp, the simulator enables the video device to provide the image at a rate that is higher than a predetermined rate,
when the actual image time stamp is later than the target time stamp, the simulator enables the video device to provide the image at a rate that is lower than the predetermined rate,
when the actual motion time stamp is prior to the target time stamp, the simulator enables the boarding device to provide the motion at a speed that is higher than a predetermined speed, and
when the actual motion time stamp is later than the target time stamp, the simulator enables the boarding device to provide the motion at a speed that is lower than the predetermined speed.

42. The experience apparatus of claim 34, wherein the boarding device includes:
a boarding part configured to provide the experiencing person with a space in which the experiencing person is able to be aboard; and
a driving part configured to generate motion on the boarding part,
wherein the driving part is configured with a robot arm having a plurality of degrees of freedom.

43. The experience apparatus of claim 34, wherein the boarding device includes:
a boarding part configured to provide the experiencing person with a space in which the experiencing person is able to be aboard; and
a driving part configured to generate motion on the boarding part,
wherein the driving part is configured with a gyro mechanism configured to generate at least one of pitching, yawing, rolling, and a reciprocal motion on the boarding part.

44. The experience apparatus of claim 34, wherein the boarding device includes:
a boarding part configured to provide the experiencing person with a space in which the experiencing person is able to be aboard; and
a driving part configured to generate motion on the boarding part,
the driving part includes:
a robot arm having a plurality of degrees of freedom; and
a gyro mechanism interposed between a free end of the robot arm and the boarding part and configured to generate at least one of pitching, yawing, rolling, and a reciprocal motion on the boarding part with respect to a free end of the robot arm.

45. The experience apparatus of claim 34, wherein the boarding device includes:
a boarding part configured to provide the experiencing person with a space in which the experiencing person is able to be aboard; and
a driving part configured to generate motion on the boarding part,
wherein the driving part is configured with a motion simulator having an arbitrary degree of freedom.

46. The experience apparatus of claim 28, wherein the simulator is configured to provide the experiencing person with the image and the motion, which are undergone by the avatar, in real time, or
to store the image and the motion, which are undergone by the avatar, and then provide the stored image and the stored motion to the experiencing person when the experiencing person wants to undergo again the image and the motion.
